(19) United States
(12) Patent Application Publication
(10) Pub. No.: US 2014/0058579 A1
(43) Pub. Date: Feb. 27, 2014

(54) DRIVING ASSIST DEVICE AND DRIVING ASSIST METHOD

(71) Applicant: Sayaka ONO, Susono-shi (JP)

(72) Inventor: Sayaka ONO, Susono-shi (JP)

(73) Assignee: TOYOTA JIDOSHA KABUSHIKI KAISHA, Toyota-shi (JP)

(21) Appl. No.: 13/965,360

(22) Filed: Aug. 13, 2013

(30) Foreign Application Priority Data
Aug. 23, 2012 (JP) 2012-184553

(51) Int. Cl. G06F 17/00

(52) U.S. Cl. CPC G06F 17/00
USPC 701/1

(57) ABSTRACT

A driving assist device including: a preceding vehicle behavior prediction unit that predicts whether a vehicle behavior of a preceding vehicle is a deceleration behavior or a non-deceleration behavior; a host vehicle behavior prediction unit that predicts whether a vehicle behavior of a host vehicle is a deceleration behavior or a non-deceleration behavior; and an assist mode determination unit that determines a mode of a driving assist to be performed for the deceleration behavior of the host vehicle, based on a combination of the predicted vehicle behavior of the preceding vehicle and the predicted vehicle behavior of the host vehicle.

### INCORPORATION BY REFERENCE

The disclosure of Japanese Patent Application No. 2012-184553 filed on Aug. 23, 2012 including the specification, drawings and abstract is incorporated herein by reference in its entirety.

### BACKGROUND OF THE INVENTION

1. Field of the Invention

The present invention relates to a driving assist device and a driving assist method.

2. Description of Related Art

Conventionally, driving assist technologies for assisting a driver in the driving of a vehicle have been developed.

For example, Japanese Patent Application Publication No. 2002-236994 (JP 2002-236994 A) describes a travel assist device that estimates the traveling direction of a preceding vehicle based on the deceleration of the preceding vehicle at an intersection and, when the preceding vehicle is predicted to turn right or left, performs automatic braking control for the host vehicle. Japanese Patent Application Publication No. 2010-134851 (JP 2010-134851 A) describes a driving assist device that, when the preceding vehicle stopping at a traffic light is going to turn right or left and the host vehicle is going to travel straight ahead, assists in starting the host vehicle at a time earlier than in other cases. Japanese Patent Application Publication No. 2010-221858 (JP 2010-221858 A) describes a driving assist device that controls the host vehicle, which is going to turn right or left at an intersection located in the estimated course, to start decelerating at a point a predetermined distance before the intersection so that the host vehicle can pass through the intersection at a target passage speed. Japanese Patent Application Publication No. 2010-244308 (JP 2010-244308 A) describes a device that notifies a driver, who is going to stop the host vehicle at a stop position before a traffic light, when to start deceleration so that the driver can start deceleration earlier.

The driving assists, described in the patent documents given above, increase fuel efficiency and make the host vehicle behavior smoother. However, in some cases, the driving assists described in the patent documents given above are not desirable to a driver. A mismatch between an actual deriving assist and a user desired driving assist sometimes leads to driver's discomfort and stress.

### SUMMARY OF THE INVENTION

The present invention provides a driving assist device and a driving assist method that can reduce driver's discomfort and perform a better driving assist.

A first aspect of the present invention is a driving assist device including: a preceding vehicle behavior prediction unit that predicts whether a vehicle behavior of a preceding vehicle is a deceleration behavior or a non-deceleration behavior; a host vehicle behavior prediction unit that predicts whether a vehicle behavior of a host vehicle is a deceleration behavior or a non-deceleration behavior; and an assist mode determination unit that determines a mode of a driving assist to be performed for the deceleration behavior of the host vehicle, based on a combination of the predicted vehicle behavior of the preceding vehicle and the predicted vehicle behavior of the host vehicle.

A second aspect of the present invention is a driving assist method including: predicting whether a vehicle behavior of a preceding vehicle is a deceleration behavior or a non-deceleration behavior; predicting whether a vehicle behavior of a host vehicle is a deceleration behavior or a non-deceleration behavior; and determining a mode of a driving assist to be performed for the deceleration behavior of the host vehicle, based on a combination of the predicted vehicle behavior of the preceding vehicle and the predicted vehicle behavior of the host vehicle.

The configurations described above reduce driver's discomfort and perform a better driving assist.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing an example of the configuration of a driving assist system in this embodiment;

FIG. 2 is a diagram showing an example of selection criteria for a plurality of driving assist modes in an embodiment;

FIG. 3 is a flowchart showing an example of driving assist processing in the embodiment;

FIG. 4A is a diagram showing an example of a first driving assist in the embodiment;

FIG. 4B is a diagram showing an example of a second driving assist in the embodiment;

FIG. 4C is a diagram showing an example of a third driving assist in the embodiment; and

FIG. 4D is a diagram showing an example of a fourth driving assist in the embodiment;

### DETAILED DESCRIPTION OF EMBODIMENTS

A driving assist device and a driving assist method of an embodiment of the present invention is described below in detail with reference to the drawings. The present invention is not limited to this embodiment. The components used in the embodiment below include components that are easily supposed by those skilled in the art and components that are substantially equivalent.

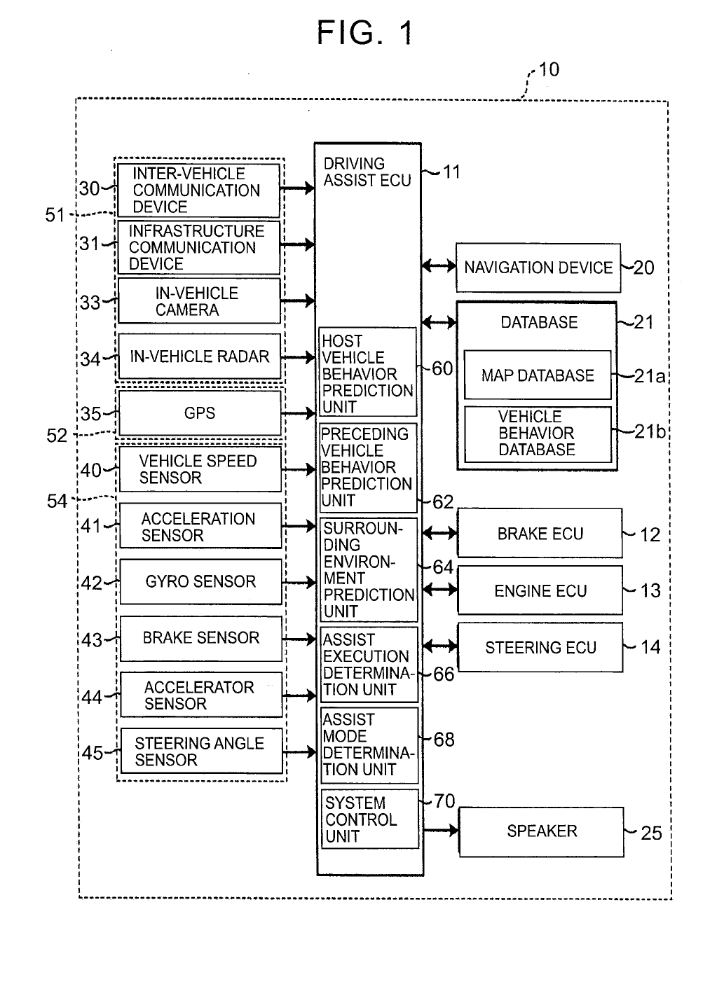

The configuration of a driving assist system in this embodiment of the present invention is described below with reference to FIG. 1. FIG. 1 is a block diagram showing an example of the configuration of the driving assist system in this embodiment.

As shown in FIG. 1, a vehicle (hereinafter sometimes called “host vehicle”) 10 includes the following: a driving assist ECU 11, a brake ECU 12, an engine ECU 13, a steering ECU 14, a navigation device 20, a database 21, a speaker 25, an inter-vehicle communication device 30, an infrastructure communication device 31, an in-vehicle camera 33, an in-vehicle radar 34, a global positioning system (GPS) 35, a vehicle speed sensor 40, an acceleration sensor 41, a gyro sensor 42, a brake sensor 43, an accelerator sensor 44, and a steering angle sensor 45. The inter-vehicle communication device 30, infrastructure communication device 31, in-vehicle camera 33, and in-vehicle radar 34 are included in a surrounding environment information acquisition unit 51 of the vehicle 10. The GPS 35 is included in a host vehicle position detection unit 52 of the vehicle 10. The vehicle speed sensor 40, acceleration sensor 41, gyro sensor 42, brake sensor 43, accelerator sensor 44, and steering angle sensor 45 are included in a host vehicle information acquisition unit 54 of the vehicle 10.

As shown in FIG. 1, the vehicle 10 includes the driving assist ECU 11 serving as a driving assist device. The driving assist ECU 11 performs various control operations for assisting a driver, who drives the vehicle 10, in the driving operation. The driving assist ECU 11 is configured mainly by a microcomputer. This microcomputer includes a CPU that executes various operation processing, a ROM that stores various control programs, a RAM that is used as a work area for storing data and for executing programs, an input/output interface, and a memory. In this embodiment, the driving assist ECU 11 performs various control operations for the driving assist, determines a time at which the driving assist is to be performed based on various conditions and, according to the determined time, outputs information and signals about the driving assist. To do so, the driving assist ECU 11 stores in advance the programs that perform the driving assist and various parameters that are used in the driving assist. The parameters include values, which indicate the characteristics and the performance of the vehicle 10, for use in the calculation of a driving assist time. The driving assist ECU 11 is connected to other components over an in-vehicle network, such as a control area network (CAN), so that the driving assist ECU 11 can communicate with those components. The components to which the driving assist ECU 11 is connected include the brake ECU 12, engine ECU 13, steering ECU 14, navigation device 20, database 21, speaker 25, inter-vehicle communication device 30, infrastructure communication device 31, in-vehicle camera 33, in-vehicle radar 34 GPS 35, vehicle speed sensor 40, acceleration sensor 41, gyro sensor 42, brake sensor 43, accelerator sensor 44, and steering angle sensor 45. The detailed configuration of the driving assist ECU 11 will be described later. Although wiring is omitted in FIG. 1, each of the components of the vehicle 10 is connected not only to the driving assist ECU 11 but also to other components over the in-vehicle network so that they can communicate with each other.

The brake ECU 12, an ECU that controls the brake device of the vehicle 10, is connected to various sensors such as the vehicle speed sensor 40 and the brake sensor 43. The brake ECU 12 controls the brake device of the vehicle 10 based on the signals from various sensors, thereby generating braking force in the vehicle 10. More specifically, the brake ECU 12 calculates the required braking force for controlling the brake device based on the following two: one is the speed of the vehicle 10 acquired based on the signal received from the vehicle speed sensor 40 and the other is the signal indicating the brake pedal force received from the brake sensor 43.

The engine ECU 13 is an ECU that controls the operation of the engine of the vehicle 10. Connected to this engine ECU 13 are the accelerator sensor 44 that detects the accelerator pedal force, the sensor that detects the induced air amount, and the driving circuits of various apparatuses such as the driving circuit of the throttle valve and the driving circuit of the fuel injection valve. The engine ECU 13 detects the engine operation status acquired based on the detection signal received from the sensors described above and, at the same time, outputs the instruction signal to the driving circuits of the apparatuses described above. In this manner, the operation of the engine is controlled via the engine ECU 13.

The steering ECU 14, an ECU that controls the steering of the vehicle 10, is connected to various sensors such as the gyro sensor 42 and the steering angle sensor 45. The steering ECU 14 controls the steering via electric assist control based on the signals received from various sensors.

As with the driving assist ECU 11 described above, each of the brake ECU 12, engine ECU 13, and steering ECU 14 is configured mainly by a microcomputer. This microcomputer includes a CPU that executes various operation processing, a ROM that stores various control programs, a RAM that is used as a work area for storing data and for executing programs, an input/output interface, and a memory.

The navigation device 20 uses the GPS 35 to detect the current position of the vehicle and, by referencing the road map information stored in advance, provides a driver with information about a travel route of the vehicle 10 to the destination.

The navigation device 20 in this embodiment acquires the road map information, stored in the database 21 in advance, for use in the processing. In addition, the navigation device 20 sends the position information on the position of the vehicle 10 and the road map information, extracted as the information on the surrounding area of the current position, to the driving assist ECU 11.

The database 21 is a device for storing data that is used in the processing of the units and data that is detected by the units. A hard disk drive (HDD), one of the nonvolatile storage devices, is used as the storage device of the database 21. The road map information, which is information on a map, includes data for displaying a road, the background of the road map, and other data such as the names of intersections. The road map information includes road-associated information such as the shape of a road and information on the intersections and pedestrian crossings on the road. More specifically, the road-associated information includes information on the positions of intersections with a traffic light, positions of stop points, road shapes, tunnels, pedestrian crossings, accident black spots, and road surface condition. That is, the road map information, which is sent from the navigation device 20 to the driving assist ECU 11, also includes road-associated information described above.

The database 21 includes a map database 21a and a vehicle behavior database 21b. The map database 21a is a database that stores road map information used for navigation processing. The vehicle behavior database 21b is a database that stores vehicle behaviors (driving actions) in which the past vehicle behaviors of the vehicle 10 are associated with specific locations or with the characteristics of specific locations. The characteristics of a location include factors that affect the vehicle behavior such as the road width, number of lanes, slope, curvature, presence/absence of infrastructure (traffic light, etc.), presence/absence of traffic regulations (positions of stop points, etc.), limiting speed, shape of an intersection, and shape of a road.

The speaker 25, electrically connected to the driving assist ECU 11, is an output device (man-machine interface) that outputs a notification according to various types of information. The speaker 25 outputs a notification via voice. The speaker 25 generates a voice or a warning sound that alerts the driver, for example, based on a notification about the driving assist. The speaker 25 outputs a voice guidance message or a warning sound according to the signal received from the driving assist ECU 11. The output device is not limited to the speaker described above. Although only the speaker is shown in FIG. 1 as the output device, various types of output devices capable of outputting information to the occupants of the vehicle 10 may be used as the output device.

Next, the components included in the surrounding environment information acquisition unit 51 are described below. The components included in the surrounding environment information acquisition unit 51 detect various types of information on the surrounding environment of the vehicle 10. For example, the surrounding environment information acquisition unit 51 acquires the information from the sensors that detect the relation with the preceding and following vehicles and the information on the travel route on which the vehicle is traveling. The inter-vehicle communication device 30 is a communication device that performs the so-called inter-vehicle communication. In the inter-vehicle communication, the inter-vehicle communication device 30 wirelessly sends and receives various types of information, such as the position information and the travel information on the vehicle 10, to and from other vehicles around the vehicle 10 (including the preceding vehicle of the vehicle 10). In the inter-vehicle communication, the inter-vehicle communication device 30 regularly sends and receives the vehicle information to and from each of a plurality of vehicles located in the area where communication is possible. The vehicle information includes the vehicle ID assigned uniquely to each vehicle, vehicle's absolute position detected by the GPS of the vehicle, vehicle's speed, vehicle's traveling direction, and vehicle's type and height. The inter-vehicle communication device 30 receives the vehicle information on other vehicles via inter-vehicle communication and sends the received vehicle information on other vehicles to the driving assist ECU 11. This allows the driving assist ECU 11 to receive the vehicle information on other vehicles and acquire the traveling status of other vehicles. In this manner, the driving assist ECU 11 can receive the vehicle information on other vehicles that might be an obstacle.

The infrastructure communication device 31 is a communication device that uses an optical signal, such as an infrared signal, to communicate with an infrastructure device installed at an intersection or on a road. The infrastructure communication device 31 receives an infrastructure information signal sent from an infrastructure device and, at the same time, sends the received infrastructure signal to the driving assist ECU 11. This allows the driving assist ECU 11 to acquire the infrastructure information. For example, the infrastructure communication device 31 receives the road traffic information, delivered from the Vehicle Information and Communication System (VICS) (registered trademark) center, via an infrastructure device as One piece of infrastructure information. This road traffic information includes traffic congestion information indicating congestion sections, congestion levels, etc., and traffic regulation information indicating traffic closures. etc. The infrastructure information also includes road-associated information such as the status of the roads (such as the shape of an intersection, curvature, slope, number of lanes) in the surrounding area of a location where an infrastructure device is installed as well as moving object information indicating the positions and the speeds of moving objects (such as other vehicles and pedestrians) around an infrastructure device detected by the ground facilities. The information described above allows the driving assist ECU 11 to receive moving object information on a moving object that might be an obstacle. In addition, the infrastructure information includes the lighting status information indicating the lighting status of the traffic lights near a location where an infrastructure device is installed. The lighting status information indicates which light of the traffic lights is on, red, yellow, or green. The lighting status information may also include information on the blink status of the red light or the yellow light and information on the status of an arrow light indicating in which direction a vehicle before the traffic light can travel.

The in-vehicle camera 33 images a predetermined range in the forward direction of the vehicle 10 via, for example, an optical CCD camera installed on the back of the room mirror and, at the same time, sends an image signal, generated based on the imaged image, to the driving assist ECU 11. Based on the image signal sent by the in-vehicle camera 33, the driving assist ECU 11 extracts information on the lighting status of the traffic light ahead of the vehicle (signal color, blink status, etc.) and information on the status of the preceding vehicles (including a vehicle traveling in the opposite direction). Upon receiving the extracted information, the driving assist ECU 11 performs the driving assist, based on the extracted lighting status of the traffic light ahead of the vehicle and on the information about the preceding vehicles, and determines whether the vehicle 10 can safely turn right or left or travel straight ahead.

The in-vehicle radar 34 emits a laser beam to a predetermined range ahead of the vehicle to detect the distance to, and the relative speed and the direction of, a reflection object (for example, a preceding vehicle) on which the laser beam is reflected. The detection result is sent to the driving assist ECU 11 for each reflection object. This allows the driving assist ECU 11 to acquire the detection information on the moving objects (including other vehicles or pedestrians) ahead of the vehicle 10. Based on this detection information, the driving assist ECU 11 can determine whether there is an obstacle as well as type of the obstacle and acquire the distance between the vehicle 10 and the obstacle.

Next, the component included in the host vehicle position detection unit 52 is described below. The GPS 35 included in the host vehicle position detection unit 52 receives a GPS satellite signal and, based on the received GPS signal, detects the absolute position of the vehicle 10. The GPS 35 sends the detected position information on the vehicle 10 to the driving assist ECU 11. This allows the driving assist ECU 11 to acquire the position of the vehicle 10.

Next, the components included in the host vehicle information acquisition unit 54 are described below. The components included in the host vehicle information acquisition unit 54 are sensors that detect various parameters while the vehicle 10 is traveling. The vehicle speed sensor 40 sends the signal, which indicates the detected rotation speed of the wheels, to the driving assist ECU 11. The acceleration sensor 41 sends the signal, which indicates the detected acceleration of the vehicle, to the driving assist ECU 11. The gyro sensor 42 sends the signal, which indicates the detected travel direction of the vehicle, to the driving assist ECU 11. The brake sensor 43 sends the signal, which indicates whether the driver's operation on the brake pedal is detected as well as the detected depression amount of the brake pedal, to the driving assist ECU 11. The accelerator sensor 44 sends the signal, which indicates whether the driver's operation on the accelerator pedal is detected as well as the detected depression amount of the accelerator pedal force, to the driving assist ECU 11. The steering angle sensor 45 sends the signal, which indicates the detected amount of change in the steering angle of the steering wheels, to the driving assist ECU 11 so that the driving assist ECU 11 can calculate the steering angle based on the received signal. The host vehicle information acquisition unit 54 may further include a turning indication detector that sends the signal, which indicates the status of the turn signal lamp of the host vehicle, to the driving assist ECU 11.

The signals received from the sensors described above are sent to the driving assist ECU 11 at a predetermined periodic interval. This allows the driving assist ECU 11 to serially acquire the vehicle status, such as the position, speed, and direction of the vehicle 10, based on the received signals.

The vehicle 10 may include a display device, a voice device, and an input device. The speaker 25 described above may be used as the voice device. The display device, configured by a liquid crystal display for example, is installed near the center console in the vehicle interior. The display device displays an image corresponding to image data received from the navigation device 20. This allows the navigation device 20 to output image data, created by combining the current position of the vehicle 10 with its surrounding map, and output the image data on the display device. The display device displays the image data of a map, received from the navigation device 20, and the image data such as a notification indicating the driving assist information received from the driving assist ECU 11. The driving assist information, provided as the information that assists the driver in driving the vehicle 10, includes information instructing the driver of the vehicle 10 how to drive the vehicle 10.

When displaying driving assist information, the display device displays simple information, which indicates whether there is an obstacle, based on the detection result of an obstacle around the vehicle 10. When there is a vehicle ahead, the display device displays the driving assist information based on the speed of, and the distance to, the preceding vehicle, to alert that the host vehicle is approaching the preceding vehicle. In addition, when there is a vehicle ahead, the display device displays the driving assist information indicating that there is a possibility that the host vehicle will collide with the preceding vehicle in certain seconds based on the time to the collision calculated from the speed of, and the distance to, the preceding vehicle. This driving assist information also gives an instruction (a warning) to inform the driver how to control the vehicle 10 to avoid the collision.

The voice device outputs sounds and voices corresponding to sound/voice data received from the navigation device 20. As the sound/voice data, the voice device receives voice information, such as route guidance and traffic information, from the navigation device 20 and voice information, corresponding to the driving assist information, from the driving assist ECU 11.

The input device, provided as a touch switch, integrated with the display device, or a mechanical switch is used for various input operations.

Next, the driving assist ECU 11 is described. The driving assist ECU 11 includes a host vehicle behavior prediction unit 60, a preceding vehicle behavior prediction unit 62, a surrounding environment prediction unit 64, an assist execution determination unit 66, an assist mode determination unit 68, and a system control unit 70.

The host vehicle behavior prediction unit 60 predicts the future vehicle behavior of the vehicle 10 based on the following two; one is the vehicle behavior at the current time or within a predetermined time acquired by the host vehicle information acquisition unit 54 and the other is the data stored in the vehicle behavior database 21b. More specifically, the host vehicle behavior prediction unit 60 compares the detected current vehicle behavior of the vehicle 10 with the corresponding vehicle behavior of the vehicle 10 stored in the vehicle behavior database 21b to predict the future vehicle behavior of the vehicle 10 stochastically. For example, the host vehicle behavior prediction unit 60 uses the vehicle behavior database 21b to predict the future vehicle behavior of the vehicle 10 based on a plurality of probabilities. These probabilities include the probability with which the vehicle 10 will perform the predetermined behavior and the probability with which the vehicle 10 will not perform the predetermined behavior. Preferably, the host vehicle behavior prediction unit 60 extracts data from the vehicle behavior database 21b, which is used in comparison with the vehicle behavior of the vehicle 10, based on the position information and the surrounding environment information. This allows the host vehicle behavior prediction unit 60 to predict the host vehicle behavior more accurately.

In this embodiment, the host vehicle behavior prediction unit 60 predicts the future vehicle behavior of the currently-traveling vehicle 10 as a deceleration behavior or a non-deceleration behavior. For example, the host vehicle behavior prediction unit 60 predicts the vehicle behavior of the vehicle 10 based on the traveling direction of the vehicle 10 acquired by the host vehicle information acquisition unit 54. In this case, the host vehicle behavior prediction unit 60 predicts that the vehicle 10 will perform a deceleration behavior when the vehicle 10 is going to turn right or left and that the vehicle 10 will perform a non-deceleration behavior when the vehicle 10 is going to travel straight ahead.

It is also possible for the host vehicle behavior prediction unit 60 to acquire the lighting status information on the traffic light in a predetermined area ahead of the vehicle 10 using the surrounding environment information acquisition unit 51 and to predict the vehicle behavior of the vehicle 10 based on the acquired lighting status information. In this case, the host vehicle behavior prediction unit 60 predicts that the vehicle 10 will perform a deceleration behavior when the lighting status information indicates a red light (or a yellow light) and that the vehicle 10 will perform a non-deceleration behavior when the lighting status information indicates a green light (or an arrow light indicating that a vehicle may travel straight ahead). It is also possible for the host vehicle behavior prediction unit 60 to acquire information on a stop point, present ahead of the vehicle 10, from the map database 21a of the database 21 and to predict the vehicle behavior of the vehicle 10 based on the presence/absence of a stop point ahead of the vehicle 10. In this case, the host vehicle behavior prediction unit 60 predicts that the vehicle 10 will perform a deceleration behavior when there is a stop point within a predetermined area ahead of the vehicle 10 and that the vehicle 10 will perform a non-deceleration behavior when there is no stop point in a predetermined area ahead of the vehicle 10.

The preceding vehicle behavior prediction unit 62 predicts the future vehicle behavior of the preceding vehicle based on the following two; one is the preceding vehicle behavior at the current time or within a predetermined time acquired by the surrounding environment information acquisition unit 51 and the other is the data stored in the vehicle behavior database 21b. The preceding vehicle behavior prediction unit 62 uses the information, acquired by at least one of the inter-vehicle communication device 30, in-vehicle camera 33, and in-vehicle radar 34 all of which belong to the surrounding environment information acquisition unit 51, to detect the vehicle behavior of the preceding vehicle at the current time or within a predetermined time. More specifically, as with the host vehicle behavior prediction unit 60, the preceding vehicle behavior prediction unit 62 compares the detected current vehicle behavior of the preceding vehicle with the corresponding vehicle behavior stored in the vehicle behavior database 21b to predict the future vehicle behavior of the preceding vehicle stochastically. Preferably, the preceding vehicle behavior prediction unit 62 extracts data from the vehicle behavior database 21b, which is used in comparison with the vehicle behavior of the preceding vehicle, based on the position information and the surrounding environment information. This allows the preceding vehicle behavior prediction unit 62 to predict the preceding vehicle behavior more accurately.

In this embodiment, the preceding vehicle behavior prediction unit 62 predicts the future vehicle behavior of the currently-traveling preceding vehicle as a deceleration behavior or a non-deceleration behavior. For example, the preceding vehicle behavior prediction unit 62 predicts the vehicle behavior of the preceding vehicle based on the traveling direction of the preceding vehicle acquired by the surrounding environment information acquisition unit 51. In this case, the preceding vehicle behavior prediction unit 62 predicts that the preceding vehicle will perform a deceleration behavior when the preceding vehicle is going to turn right or left and that the preceding vehicle will perform a non-deceleration behavior when the preceding vehicle is going to travel straight ahead.

It is also possible for the preceding vehicle behavior prediction unit 62 to acquire the lighting status information on the traffic light in a predetermined area ahead of the preceding vehicle using the surrounding environment information acquisition unit 51 and to predict the vehicle behavior of the preceding vehicle based on the acquired lighting status information. In this case, the preceding vehicle behavior prediction unit 62 predicts that the preceding vehicle will perform a deceleration behavior when the lighting status information indicates a red light (or a yellow light) and that the preceding vehicle will perform a non-deceleration behavior when the lighting status information indicates a green light (or an arrow light indicating that a vehicle may travel straight ahead). It is also possible for the preceding vehicle behavior prediction unit 62 to acquire information on a stop point, present ahead of the preceding vehicle, from the map database 21a of the database 21 and to predict the vehicle behavior of the preceding vehicle based on the presence/absence of a stop point ahead of the preceding vehicle. In this case, the preceding vehicle behavior prediction unit 62 predicts that the preceding vehicle will perform a deceleration behavior when there is a stop point within a predetermined area ahead of the preceding vehicle and that the preceding vehicle will perform a non-deceleration behavior when there is no stop point in a predetermined area ahead of the preceding vehicle.

The host vehicle behavior prediction unit 60 and the preceding vehicle behavior prediction unit 62 may use the same data, stored in the vehicle behavior database 21b, to predict the vehicle behavior. Instead, with the vehicle behavior data on the host vehicle and the vehicle behavior data on the preceding vehicle stored separately in the database 21, the host vehicle behavior prediction unit 60 and preceding vehicle behavior prediction unit 62 each may use respective vehicle behavior data to predict the vehicle behavior.

The surrounding environment prediction unit 64 predicts the surrounding environment based on the information acquired by the host vehicle position detection unit 52 and the surrounding environment information acquisition unit 51. More specifically, the surrounding environment prediction unit 64 predicts whether the vehicle will pass through an area where the vehicle will turn right or left, for example, whether the vehicle will pass through an intersection or a point where there are facilities adjacent to a road.

Although the host vehicle behavior prediction unit 60, preceding vehicle behavior prediction unit 62, and surrounding environment prediction unit 64 in this embodiment acquire a prediction result by carrying out an analysis based on various types of information acquired from the components of the vehicle 10, the present invention is not limited to this method. The host vehicle behavior prediction unit 60, preceding vehicle behavior prediction unit 62, and surrounding environment prediction unit 64 may acquire a prediction result calculated by other apparatuses. That is, another apparatus may perform the processing for calculating a prediction result by carrying out an analysis based on various types of information. For example, it is possible for the vehicle 10 to include a communication unit via which the vehicle 10 communicates with a server to acquire a prediction result from the server. It is also possible for the preceding vehicle behavior prediction unit 62 to receive, via the inter-vehicle communication device 30, a vehicle behavior prediction result of the preceding vehicle for use in predicting the future vehicle behavior of the preceding vehicle. In this case, the vehicle behavior prediction result of the preceding vehicle is the one predicted by the preceding vehicle, whose behavior is to be predicted, using the vehicle behavior database of the preceding vehicle.

The assist execution determination unit 66 determines whether to perform the driving assist based on the surrounding environment predicted by the surrounding environment prediction unit 64. In this embodiment, the assist execution determination unit 66 determines whether the surrounding environment of the vehicle 10, predicted by the surrounding environment prediction unit 64, corresponds to a location (or the surrounding area of the location) where the past vehicle behaviors of the vehicle 10, stored in the vehicle behavior database 21b of the database 21, are divided into a plurality of patterns. If it is determined that the surrounding environment of the vehicle 10 corresponds to a location where the vehicle behaviors of the vehicle 10 are divided into a plurality of patterns (that is, an assist execution location), the assist execution determination unit 66 determines to perform the driving assist.

The assist mode determination unit 68 determines the driving assist mode to be performed for the deceleration behavior of the vehicle 10 according to the vehicle behavior prediction result of the vehicle 10 and the vehicle behavior prediction result of the preceding vehicle. The driving assist includes the output control that informs about the driving assist information for assisting the driver in the deceleration behavior of the vehicle 10 and the deceleration control that assists the driver in the deceleration behavior of the vehicle 10. The driving assist may also include the control that notifies about the deceleration control start time as an energy loss reduction assist of the vehicle 10 and the regenerative brake region increase control that is used when the vehicle 10 is a hybrid vehicle (HV) or an electric vehicle (EV).

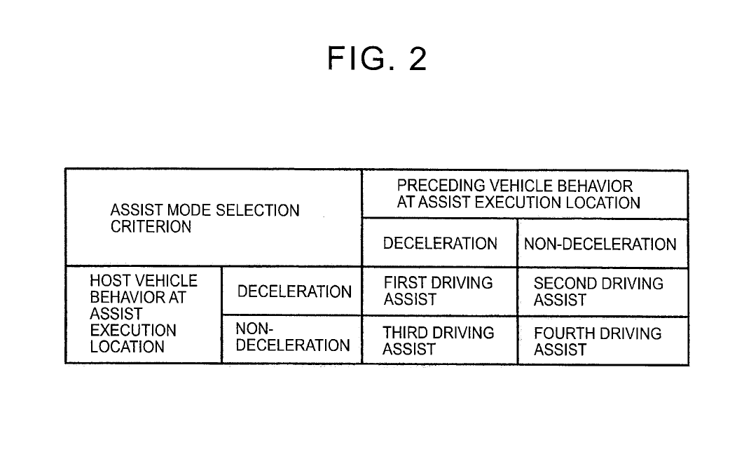

The assist mode determination unit 68 in this embodiment determines the driving assist mode to be performed based on the criteria shown in FIG. 2. FIG. 2 is a diagram showing an example of a plurality of selection criteria for the driving assist modes in this embodiment. As shown in FIG. 2, the assist mode determination unit 68 changes the driving assist to be performed, based on whether the prediction result of the vehicle behavior of the vehicle 10 is the deceleration behavior or the non-deceleration behavior and whether the prediction result of the vehicle behavior of the preceding vehicle is the deceleration behavior or the non-deceleration behavior. More specifically, if the prediction result of the vehicle behavior of the preceding vehicle is the deceleration behavior and the prediction result of the vehicle behavior of the host vehicle is the deceleration behavior, the assist mode determination unit 68 determines to perform the first driving assist. If the prediction result of the vehicle behavior of the preceding vehicle is the non-deceleration behavior and the prediction result of the vehicle behavior of the host vehicle is the deceleration behavior, the assist mode determination unit 68 determines to perform the second driving assist. If the prediction result of the vehicle behavior of the preceding vehicle is the deceleration behavior and the prediction result of the vehicle behavior of the host vehicle is the non-deceleration behavior, the assist mode determination unit 68 determines to perform the third driving assist. If the prediction result of the vehicle behavior of the preceding vehicle is the non-deceleration behavior and the prediction result of the vehicle behavior of the host vehicle is the non-deceleration behavior, the assist mode determination unit 68 determines to perform the fourth driving assist. The first driving assist to the fourth driving assist will be described later.

The system control unit 70 controls the operation of the components of the driving assist ECU 11. The system control unit 70 controls the operation of the components, based on the driving assist mode determined by the assist mode determination unit 68, for executing the driving assist. To perform the deceleration control, the system control unit 70 performs the brake control, engine control, or steering control via the brake ECU 12, engine ECU 13, or steering ECU 14. The system control unit 70 outputs the driving assist information from at least one of the output devices (man-machine interface), i.e., one of the display device, speaker 25, and voice device, to the driver. The output device is a device that generates a voice or a warning sound to alert the driver based on a notification about the driving assist. The speaker 25, when used as the output device, outputs a voice guidance message or a warning sound according to the signal output from the system control unit 70.

When the surrounding environment does not satisfy a predetermined condition, the driving assist ECU 11 may perform another driving assist. More specifically, when the surrounding environment does not satisfy a predetermined condition, the driving assist mode to be performed is not determined from a plurality of driving assist modes based on the host vehicle behavior and the preceding vehicle behavior; instead, the driving assist may be performed in a pre-set driving assist mode. In this case, the driving assist ECU 11 may perform the driving assist for the vehicle 10 based on a prediction result indicating whether there is a factor that may affect the vehicle behavior of the vehicle 10 and, if there is such a factor, the degree of its effect. The factor that may affect the vehicle behavior of the vehicle 10 includes a situation in which the vehicle 10 needs to decelerate, for example, because a pedestrian is crossing the pedestrian crossing ahead of the vehicle 10.

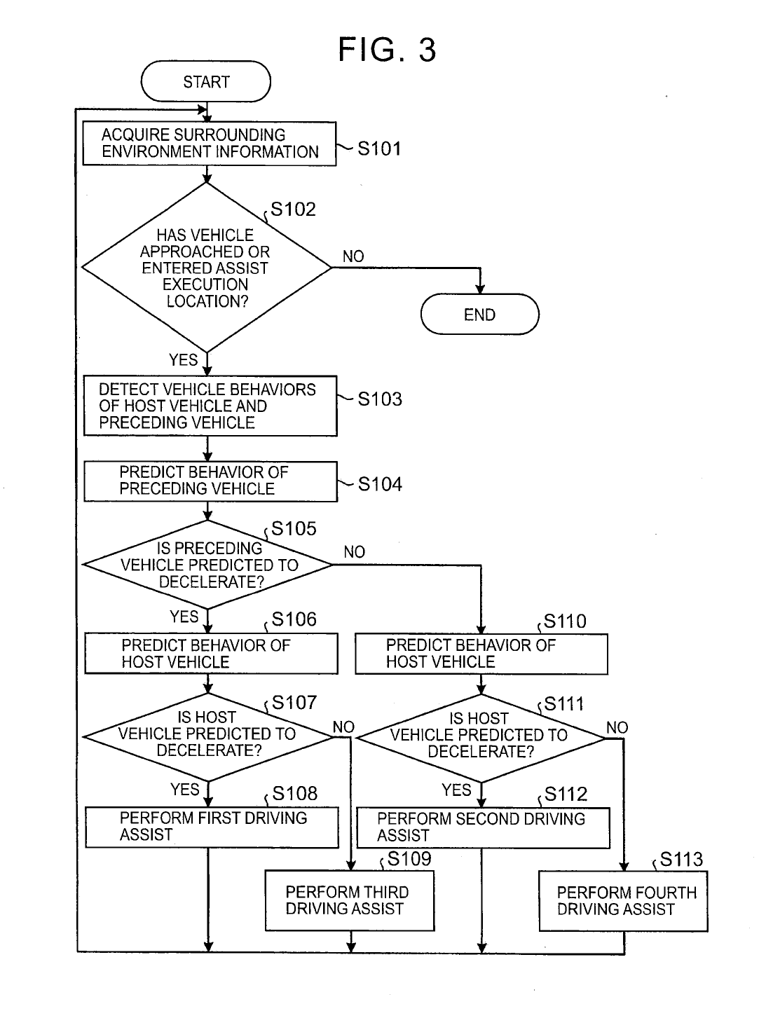

Next, the driving assist processing in this embodiment, performed by the driving assist ECU 11 with the above-described configuration, is described in detail below with reference to FIG. 3. FIG. 3 is a flowchart showing an example of the driving assist processing in this embodiment.

As shown in FIG. 3, the driving assist ECU 11 uses the surrounding environment prediction unit 64 to acquire information on the surrounding environment of the vehicle 10 from the surrounding environment information acquisition unit 51 (step S101). For example, in step S101 the driving assist ECU 11 acquires vehicle information on other vehicles (including the preceding vehicle), located around the vehicle 10, from the inter-vehicle communication device 30 of the surrounding environment information acquisition unit 51. The driving assist ECU 11 may also acquire moving object information on other vehicles and pedestrians around the vehicle 10 from the infrastructure communication device 31 of the surrounding environment information acquisition unit 51. The driving assist ECU 11 may also acquire the infrastructure information, including the road traffic information and the lighting status information, from the infrastructure communication device 31 of the surrounding environment information acquisition unit 51. The driving assist ECU 11 may also acquire the road map information, including the information on stop points around the vehicle 10, from the database 21.

The driving assist ECU 11 uses the surrounding environment prediction unit 64 and the assist execution determination unit 66 to determine whether the vehicle 10 has approached an assist execution location (or has entered an assist execution location) where the driving assist is performed for the vehicle 10 (step S102). For example, in step S102, the driving assist ECU 11 uses the surrounding environment prediction unit 64 to predict the surrounding environment and uses the assist execution determination unit 66 to determine whether the predicted surrounding environment corresponds to a location where the vehicle behavior of the vehicle 10 was divided into a plurality of patterns in the past. In this manner, the driving assist ECU 11 determines whether the vehicle has approached an assist execution location. In this embodiment, the driving assist ECU 11 sets a location, where the past vehicle behavior of the vehicle 10 is divided into a plurality of patterns, as an assist execution location. The surrounding environment prediction unit 64 may also predict the surrounding environment based on the current position of the vehicle 10 identified by the GPS 35. The assist execution determination unit 66 may also communicate with the driving assist service center, in which assistant execution locations are stored for each surrounding environment, to confirm an assist execution location and then determine whether the vehicle has approached the assist execution location.

If it is determined in step S102 that the vehicle has not yet approached an assist execution location (step S102: No), the driving assist ECU 11 terminates this processing.

If it is determined in step S102 that the vehicle has approached an assist execution location (step S102: Yes), the driving assist ECU 11 detects the vehicle behaviors of the vehicle 10 (host vehicle) and the preceding vehicle (step S103). For example, in step S103, the driving assist ECU 11 detects the vehicle behavior of the vehicle 10 based on the information acquired by the host vehicle information acquisition unit 54. In addition, the driving assist ECU 11 detects the vehicle behavior of the preceding vehicle based on the information acquired by the surrounding environment information acquisition unit 51 in step S101.

The driving assist ECU 11 uses the preceding vehicle behavior prediction unit 62 to predict the vehicle behavior of the preceding vehicle based on the vehicle behavior of the preceding vehicle detected in step S103 (step S104). For example, in step S104, the driving assist ECU 11 uses the preceding vehicle behavior prediction unit 62 to compare the detected current vehicle behavior of the preceding vehicle with the corresponding vehicle behavior of the preceding vehicle stored in the vehicle behavior database 21b to predict the future vehicle behavior of the preceding vehicle. The preceding vehicle behavior prediction unit 62 in this embodiment predicts whether the preceding vehicle will decelerate or not. That is, the preceding vehicle behavior prediction unit 62 in this embodiment predicts whether the preceding vehicle will perform the deceleration behavior or the non-deceleration behavior. For example, the preceding vehicle behavior prediction unit 62 predicts the vehicle behavior of the preceding vehicle based on the traveling direction of the preceding vehicle detected in step S103. The preceding vehicle behavior prediction unit 62 may also predict the vehicle behavior of the preceding vehicle based on the infrastructure information including the lighting status information acquired in step S101. The preceding vehicle behavior prediction unit 62 may also predict the vehicle behavior of the preceding vehicle based on the road map information, including information on a stop point, acquired in step S101.

The driving assist ECU 11 determines whether the preceding vehicle is predicted to perform the deceleration behavior based on the vehicle behavior prediction result of the preceding vehicle predicted in step S104 (step S105).

If it is predicted in step S105 that the preceding vehicle will perform the deceleration behavior (step S105: Yes), the driving assist ECU 11 uses the host vehicle behavior prediction unit 60 to predict the vehicle behavior of the vehicle 10 (behavior of host vehicle) based on the vehicle behavior of the vehicle 10 detected in step S103 (step S106). For example, in step S106, the driving assist ECU 11 uses the host vehicle behavior prediction unit 60 to compare the detected current vehicle behavior of the vehicle 10 with the corresponding vehicle behavior of the vehicle 10 stored in the vehicle behavior database 21b to predict the future vehicle behavior of the vehicle 10. The host vehicle behavior prediction unit 60 in this embodiment predicts whether the vehicle 10 will decelerate or not. That is, the host vehicle behavior prediction unit 60 in this embodiment predicts whether the vehicle 10 will perform deceleration behavior or the non-deceleration behavior. For example, the host vehicle behavior prediction unit 60 predicts the vehicle behavior of the vehicle 10 based on the traveling direction of the vehicle 10 detected in step S103. The host vehicle behavior prediction unit 60 may also predict the vehicle behavior of the vehicle 10 based on the infrastructure information including the lighting status information acquired in step S101. The host vehicle behavior prediction unit 60 may also predict the vehicle behavior of the vehicle 10 based on the road map information, including information on a stop point, acquired in step S101.

The driving assist ECU 11 determines whether the vehicle 10 is predicted to perform the deceleration behavior based on the vehicle behavior prediction result of the vehicle 10 predicted in step S106 (step S107).

In step S107, if the vehicle 10 is predicted to perform the deceleration behavior (step S107: Yes), the driving assist ECU 11 uses the assist mode determination unit 68 to determine to perform the first driving assist as the driving assist for the vehicle 10 and then performs the first driving assist (step S108). That is, as shown in FIG. 2, when the preceding vehicle behavior at the assist execution location is the deceleration behavior (step S105: Yes) and when the host vehicle behavior at the assist execution location is the deceleration behavior (step S107: Yes), the driving assist ECU 11 performs the first driving assist. After that, the processing proceeds to the processing in step S101.

In step S107, if the vehicle 10 is predicted not to perform the deceleration behavior (non-deceleration behavior) (step S107: No), the driving assist ECU 11 uses the assist mode determination unit 68 to determine to perform the third driving assist as the driving assist for the vehicle 10 and then performs the third driving assist (step S109). That is, as shown in FIG. 2, when the preceding vehicle behavior at the assist execution location is the deceleration behavior (step S105: Yes) and when the host vehicle behavior at the assist execution location is the non-deceleration behavior (step S107: No), the driving assist ECU 11 performs the third driving assist. After that, the processing proceeds to the processing in step S101.

Returning to step S105 in FIG. 3, the description of the driving assist processing is continued. In step S105, if the preceding vehicle is predicted not to perform the deceleration behavior (step S105: No), the driving assist ECU 11 uses the host vehicle behavior prediction unit 60 to predict the vehicle behavior of the vehicle 10 (host vehicle behavior) based on the vehicle behavior of the vehicle 10 detected in step S103 (step S110).

The driving assist ECU 11 determines whether the vehicle 10 is predicted to perform the deceleration behavior based on the vehicle behavior prediction result of the vehicle 10 predicted in step S110 (step S111).

In step S111, if the vehicle 10 is predicted to perform the deceleration behavior (step S111: Yes), the driving assist ECU 11 uses the assist mode determination unit 68 to determine to perform the second driving assist as the driving assist for the vehicle 10 and then performs the second driving assist (step S112). That is, as shown in FIG. 2, when the preceding vehicle behavior at the assist execution location is the non-deceleration behavior (step S105: No) and when the host vehicle behavior at the assist execution location is the deceleration behavior (step S111: Yes), the driving assist ECU 11 performs the second driving assist. After that, the processing proceeds to the processing in step S101.

In step S111, if the vehicle 10 is predicted not to perform the deceleration behavior (step S111: No), the driving assist ECU 11 uses the assist mode determination unit 68 to determine to perform the fourth driving assist as the driving assist for the vehicle 10 and then performs the fourth driving assist (step S113). That is, as shown in FIG. 2, when the preceding vehicle behavior at the assist execution location is the non-deceleration behavior (step S105: No) and when the host vehicle behavior at the assist execution location is the non-deceleration behavior (step S111: No), the driving assist ECU 11 performs the fourth driving assist. After that, the processing proceeds to the processing in step S101. The driving assist ECU repeats the processing shown in FIG. 3 to perform the driving assist according to the vehicle behavior predicted at the assist execution location.

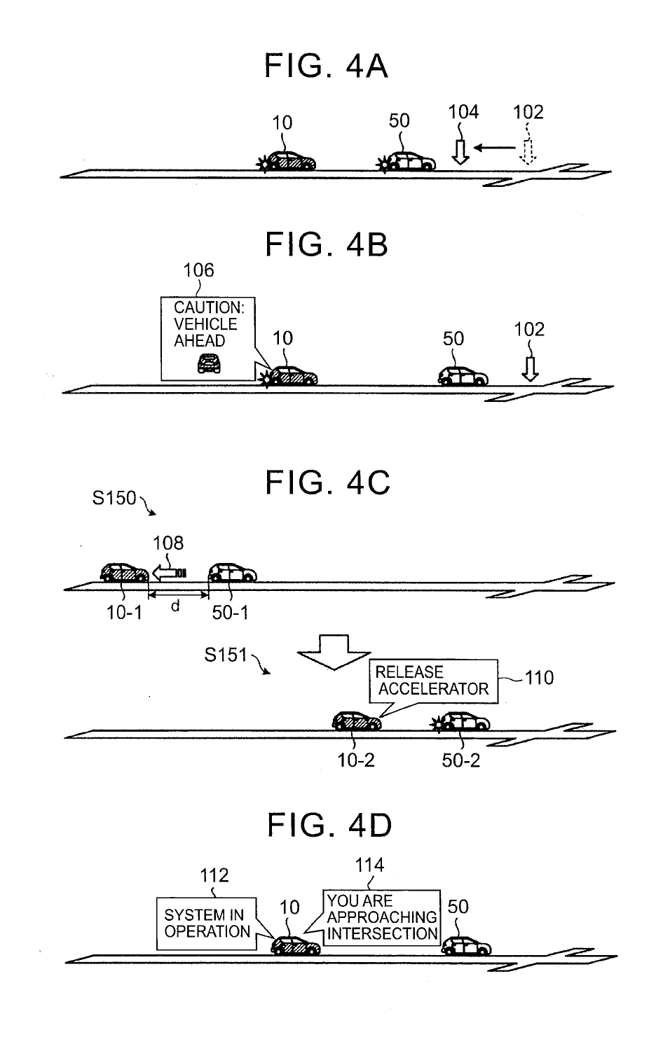

Next, an example of the mode of each driving assist performed for the deceleration behavior of the host vehicle is described with reference to FIG. 4A to FIG. 4D. FIG. 4A is a diagram showing an example of the first driving assist in this embodiment. FIG. 4B is a diagram showing an example of the second driving assist in this embodiment. FIG. 4C is a diagram showing an example of the third driving assist in this embodiment. FIG. 4D is a diagram showing an example of the fourth driving assist in this embodiment. In FIG. 4A to FIG. 4D, examples are shown in which the driving assist mode is determined by predicting the vehicle behavior of the vehicle 10 and the vehicle behavior of the preceding vehicle when the vehicle 10 is traveling toward an intersection within a predetermined distance. Because the assist execution location is the intersection or a point near the intersection, it is determined that the vehicle 10 will turn right or left at the intersection (that is, turn at the intersection) when the vehicle 10 is predicted to perform the deceleration behavior and that the vehicle 10 will travel straight ahead through the intersection when the vehicle 10 is predicted to perform the non-deceleration behavior. That is, the driving assist can be performed according to the vehicle behavior. As the vehicle behavior, it is also possible to predict, not the deceleration behavior or non-deceleration behavior, but the traveling direction itself (for example, right/left turn or straight ahead) of the vehicle.

For example, when a preceding vehicle 50 is predicted to decelerate and the vehicle 10 is predicted to decelerate as shown in FIG. 4A, the driving assist ECU 11 determines that both the preceding vehicle 50 and the host vehicle 10 will turn right or left and performs the first driving assist so that the vehicle 10 can turn right or left easily. In this case, as the first driving assist, the vehicle 10 performs the driving assist in such a way that the energy loss of the host vehicle is reduced while avoiding collision with the preceding vehicle 50. More specifically, the driving assist ECU 11 adjusts the target deceleration position and the target speed of the vehicle 10 based on the deceleration prediction result of the preceding vehicle 50 and adjusts the display content of the human-machine interface (HMI) for the vehicle 10 at a deceleration assist time and the control parameters at a deceleration assist time. In this way, as the first driving assist, the driving assist ECU 11 controls the accelerator release time, or the deceleration at the accelerator release time, of the vehicle 10 so that the vehicle 10 does not collide with the preceding vehicle 50. More specifically, by shifting the deceleration target position from a deceleration target position 102, which is initially set, to a deceleration target position 104 nearer to the vehicle 10, the driving assist ECU 11 performs the driving assist so that the vehicle 10 stops at the deceleration target position 104.

For example, when the preceding vehicle 50 is predicted not to decelerate and the vehicle 10 is predicted to decelerate as shown in FIG. 4B, the driving assist ECU 11 determines that the preceding vehicle 50 will travel straight ahead and the host vehicle 10 will turn right or left and performs the second driving assist so that the vehicle 10 can turn right or left easily. More specifically, as the second driving assist, the vehicle 10 performs the driving assist so that the vehicle decelerates at an appropriate pace. As the second driving assist, the driving assist ECU 11 displays a message 106 “Caution: Vehicle ahead” to alert against the preceding vehicle 50 to prevent driver's overconfidence. The driving assist ECU 11 may also perform the deceleration assist for the vehicle 10 as the second driving assist. The deceleration assist includes an assist to decelerate the vehicle 10 by an engine brake or via regenerative brake control and an assist to output a message recommending the driver to apply the brake. When the preceding vehicle 50 is predicted not to decelerate and the vehicle 10 is predicted to decelerate, the driving assist ECU 11 performs the second driving assist different from the first driving assist. In this way, the driving assist ECU 11 of the present invention can perform the driving assist of a mode suitable for a combination of the vehicle behavior of the host vehicle and the vehicle behavior of the preceding vehicle.

For example, when the preceding vehicle 50 is predicted to decelerate and the vehicle 10 is predicted not to decelerate as shown in FIG. 4C, the driving assist ECU 11 determines that the preceding vehicle 50 will turn right or left and the host vehicle 10 will travel straight ahead and performs the third driving assist so that the vehicle 10 can travel straight ahead easily. More specifically, the vehicle 10 performs the third driving assist so that the vehicle 10 can pass through the intersection without decelerating (without depressing the brake pedal) as much as possible while smoothly passing the preceding vehicle 50. More specifically, as the third driving assist, the driving assist ECU 11 first performs the driving assist in step S150 in FIG. 4C to adjust the distance d between two vehicles (preceding vehicle 50-1 and vehicle 10-1) before the intersection. More specifically, the driving assist ECU 11 performs the driving assist so that force is applied to the vehicle 10-1 in the direction of an arrow 108, that is, in the direction of deceleration. That is, the driving assist ECU 11 performs the deceleration control. This deceleration control increases the distance d between two vehicles, maintains the distance d between two vehicles, or slows the speed to narrow the distance d between two vehicles. In step S151, the driving assist ECU 11 displays a message 110 to direct the driver to release the accelerator according to the relative relation between the preceding vehicle and the vehicle 10. The driving assist ECU 11 may also perform the deceleration assist such as the regenerative brake region increase control. As described above, when the preceding vehicle 50 is predicted to decelerate and the vehicle 10 is predicted not to decelerate, the driving assist ECU 11 performs the third driving assist (see FIG. 4C) different from the first driving assist (see FIG. 4A). In this way, the driving assist ECU 11 of the present invention can perform the driving assist of a mode suitable for the case in FIG. 4A and FIG. 4C.

For example, when the preceding vehicle 50 does not decelerate and the vehicle 10 does not decelerate as shown in FIG. 4D, the driving assist ECU 11 determines that the preceding vehicle 50 will travel straight ahead and the host vehicle 10 will travel straight ahead and performs the fourth driving assist so that the vehicle 10 can travel straight ahead easily. More specifically, the driving assist ECU 11 performs the driving assist assuming that the vehicle 10 will continue traveling because the preceding vehicle 50 does not decelerate. As the fourth driving assist, the driving assist ECU 11 does not perform the driving assist such as a traveling control operation. Instead, the driving assist ECU 11 performs the driving assist by providing information such as a message 112 “System in operation” or a message 114 “You are approaching intersection” to prevent overconfidence of the driver of the vehicle 10.

The driving assist ECU 11 in the embodiment described above performs the driving assist for use when a vehicle enters an intersection. Therefore, based on the result of prediction whether the host vehicle and the preceding vehicle will decelerate, the driving assist ECU 11 predicts whether the vehicle will travel straight ahead or turn right or left and then performs the driving assist. However, the present invention is not limited to this driving assist. The driving assist ECU 11 may also determine the mode of the driving assist based on the vehicle behavior patterns of the host vehicle and the preceding vehicle. The driving assist ECU 11 may also predict vehicle behaviors other than a straight-ahead travel and a right/left turn based on the prediction result whether the vehicle will decelerate. Although there is one preceding vehicle in the embodiment described above, there may be a plurality of preceding vehicles.

The driving assist device in the embodiment described above takes into consideration the prediction result of the vehicle behavior of the vehicle 10 as well as the prediction result of the vehicle behavior of the preceding vehicle as described above, thus making it possible to determine the mode of the driving assist suitable for different situations. For example, the driving assist device in the embodiment described above takes into consideration not only the vehicle behavior predicted according to the traveling direction of the preceding vehicle but also the vehicle behavior predicted according to the traveling direction of the vehicle 10, thus making it possible to perform the driving assist, such as a deceleration control operation, suitable for the vehicle 10. This reduces driver's discomfort when the driving assist is performed. The driving assist device in the embodiment described above performs the driving assist suitable for different situations to increase the reliability of drivers who use the driving assist system. In addition, the driving assist device in the embodiment described above performs the driving assist based on the prediction results of the vehicle behavior of the vehicle 10 and the vehicle behavior of the preceding vehicle. This ensures fuel efficiency better than that of the conventional driving assist in which the driving assist is performed based only on the prediction result of the vehicle behavior of the vehicle 10 or based only on the prediction result of the vehicle behavior of the preceding vehicle.

Thus, according to one aspect of the present invention, a driving assist device include: a preceding vehicle behavior prediction unit that predicts whether a vehicle behavior of a preceding vehicle is a deceleration behavior or a non-deceleration behavior; a host vehicle behavior prediction unit that predicts whether a vehicle behavior of a host vehicle is a deceleration behavior or a non-deceleration behavior; and an assist mode determination unit that determines a mode of a driving assist to be performed for the deceleration behavior of the host vehicle based on a combination of the predicted vehicle behavior of the preceding vehicle and the predicted vehicle behavior of the host vehicle.

The assist mode determination unit may determine to perform a first driving assist as the driving assist if a predicted result of the vehicle behavior of the preceding vehicle is a deceleration behavior and if a predicted result of the vehicle behavior of the host vehicle is a deceleration behavior, a second driving assist as the driving assist if the predicted result of the vehicle behavior of the preceding vehicle is a non-deceleration behavior and if the predicted result of the vehicle behavior of the host vehicle is a deceleration behavior, a third driving assist as the driving assist if the predicted result of the vehicle behavior of the preceding vehicle is a deceleration behavior and if the predicted result of the vehicle behavior of the host vehicle is a non-deceleration behavior, and a fourth driving assist as the driving assist if the predicted result of the vehicle behavior of the preceding vehicle is a non-deceleration behavior and if the predicted result of the vehicle behavior of the host vehicle is a non-deceleration behavior.

The driving assist device may further includes a surrounding environment prediction unit that predicts a surrounding environment of the host vehicle; and an assist execution determination unit that determines whether to perform the driving assist, based on the surrounding environment predicted by the surrounding environment prediction unit.

The driving assist device may further includes a vehicle behavior database that stores a past vehicle behavior of the host vehicle in association with a particular location or characteristics of the particular location wherein the assist execution determination unit may determine whether the surrounding environment predicted by the surrounding environment prediction unit corresponds to a location where a past vehicle behavior of the host vehicle stored in the vehicle behavior database is divided into a plurality of patterns and, if the surrounding environment predicted by the surrounding environment prediction unit corresponds to the location where the past vehicle behavior of the host vehicle is divided into a plurality of patterns, may determine to perform the driving assist.

The driving assist may include provision of driving assist information for assisting the host vehicle in the deceleration behavior.

The preceding vehicle behavior prediction unit may predict the vehicle behavior of the preceding vehicle based on a traveling direction of the preceding vehicle, and the host vehicle behavior prediction unit may predict the vehicle behavior of the host vehicle based on a traveling direction of the host vehicle.

The preceding vehicle behavior prediction unit may predict the vehicle behavior of the preceding vehicle based on lighting status information of a traffic light installed in front of the preceding vehicle, and the host vehicle behavior prediction unit may predict the vehicle behavior of the host vehicle lighting status information of a traffic light installed in front of the host vehicle.

The preceding vehicle behavior prediction unit may predict the vehicle behavior of the preceding vehicle based on whether there is a stop point in front of the preceding vehicle, and the host vehicle behavior prediction unit may predict the vehicle behavior of the host vehicle based on whether there is a stop point in front of the host vehicle.

The assist mode determination unit may determine a mode of the driving assist performed for the deceleration behavior of the host vehicle at an intersection or a point near the intersection.

If a prediction result of the vehicle behavior of the preceding vehicle is a deceleration behavior and if a prediction result of the vehicle behavior of the host vehicle is a deceleration behavior, the assist mode determination unit may determine to perform a first driving assist for assisting the host vehicle in deceleration based on the prediction result of the vehicle behavior of the preceding vehicle.

If a prediction result of the vehicle behavior of the preceding vehicle is a non-deceleration behavior and if a prediction result of the vehicle behavior of the host vehicle is a deceleration behavior, the assist mode determination unit may determine to perform a second driving assist for providing information on the preceding vehicle or for assisting the host vehicle in deceleration.

If a prediction result of the vehicle behavior of the preceding vehicle is a deceleration behavior and if a prediction result of the vehicle behavior of the host vehicle is a non-deceleration behavior, the assist mode determination unit may determine to perform a third driving assist for adjusting a distance between the preceding vehicle and the host vehicle before the intersection.

If the prediction result of the vehicle behavior of the preceding vehicle is a non-deceleration behavior and if the prediction result of the vehicle behavior of the host vehicle is a non-deceleration behavior, the assist mode determination unit may determine to perform a fourth driving assist for providing information.

What is claimed is:

1. A driving assist device comprising:
a preceding vehicle behavior prediction unit that predicts whether a vehicle behavior of a preceding vehicle is a deceleration behavior or a non-deceleration behavior;
a host vehicle behavior prediction unit that predicts whether a vehicle behavior of a host vehicle is a deceleration behavior or a non-deceleration behavior; and
an assist mode determination unit that determines a mode of a driving assist to be performed for the deceleration behavior of the host vehicle, based on a combination of the predicted vehicle behavior of the preceding vehicle and the predicted vehicle behavior of the host vehicle.

2. The driving assist device according to claim 1, wherein:
the assist mode determination unit determines to perform a first driving assist as the driving assist if a predicted result of the vehicle behavior of the preceding vehicle is a deceleration behavior and if a predicted result of the vehicle behavior of the host vehicle is a deceleration behavior;
the assist mode determination unit determines to perform a second driving assist as the driving assist if the predicted result of the vehicle behavior of the preceding vehicle is a non-deceleration behavior and if the predicted result of the vehicle behavior of the host vehicle is a deceleration behavior;
the assist mode determination unit determines to perform a third driving assist as the driving assist if the predicted result of the vehicle behavior of the preceding vehicle is a deceleration behavior and if the predicted result of the vehicle behavior of the host vehicle is a non-deceleration behavior; and
the assist mode determination unit determines to perform a fourth driving assist as the driving assist if the predicted result of the vehicle behavior of the preceding vehicle is a non-deceleration behavior and if the predicted result of the vehicle behavior of the host vehicle is a non-deceleration behavior.

3. The driving assist device according to claim 1, further comprising:
a surrounding environment prediction unit that predicts a surrounding environment of the host vehicle; and
an assist execution determination unit that determines whether to perform the driving assist, based on the surrounding environment predicted by the surrounding environment prediction unit.

4. The driving assist device according to claim 3, further comprising:
a vehicle behavior database that stores a past vehicle behavior of the host vehicle in association with a particular location or characteristics of the particular location, wherein
the assist execution determination unit determines whether the surrounding environment predicted by the surrounding environment prediction unit corresponds to a location where a past vehicle behavior of the host vehicle stored in the vehicle behavior database is divided into a plurality of patterns and, if the surrounding environment predicted by the surrounding environment prediction unit corresponds to the location where the past vehicle behavior of the host vehicle is divided into the plurality of patterns, determines to perform the driving assist.

5. The driving assist device according to claim 1, wherein the driving assist includes provision of driving assist information for assisting the host vehicle in the deceleration behavior.

6. The driving assist device according to claim 1, wherein:
the preceding vehicle behavior prediction unit predicts the vehicle behavior of the preceding vehicle based on a traveling direction of the preceding vehicle; and
the host vehicle behavior prediction unit predicts the vehicle behavior of the host vehicle based on a traveling direction of the host vehicle.

7. The driving assist device according to claim 1, wherein:
the preceding vehicle behavior prediction unit predicts the vehicle behavior of the preceding vehicle based on lighting status information of a traffic light installed in front of the preceding vehicle; and
the host vehicle behavior prediction unit predicts the vehicle behavior of the host vehicle based on lighting status information of a traffic light installed in front of the host vehicle.

8. The driving assist device according to claim 1, wherein:
the preceding vehicle behavior prediction unit predicts the vehicle behavior of the preceding vehicle based on whether there is a stop point in front of the preceding vehicle; and
the host vehicle behavior prediction unit predicts the vehicle behavior of the host vehicle based on whether there is a stop point in front of the host vehicle.

9. The driving assist device according to claim 1, wherein the assist mode determination unit determines a mode of the driving assist performed for the deceleration behavior of the host vehicle at an intersection or a point near the intersection.

10. The driving assist device according to claim 9, wherein, if a prediction result of the vehicle behavior of the preceding vehicle is a deceleration behavior and if a prediction result of the vehicle behavior of the host vehicle is a deceleration behavior, the assist mode determination unit determines to perform a first driving assist for assisting the host vehicle in deceleration based on the prediction result of the vehicle behavior of the preceding vehicle.

11. The driving assist device according to claim 9, wherein, if a prediction result of the vehicle behavior of the preceding vehicle is a non-deceleration behavior and if a prediction result of the vehicle behavior of the host vehicle is a deceleration behavior, the assist mode determination unit determines to perform a second driving assist for providing information on the preceding vehicle or for assisting the host vehicle in deceleration.

12. The driving assist device according to claim 9, wherein, if a prediction result of the vehicle behavior of the preceding vehicle is a deceleration behavior and if a prediction result of the vehicle behavior of the host vehicle is a non-deceleration behavior, the assist mode determination unit determines to perform a third driving assist for adjusting a distance between the preceding vehicle and the host vehicle before the intersection.

13. The driving assist device according to claim 9, wherein, if the prediction result of the vehicle behavior of the preceding vehicle is a non-deceleration behavior and if the prediction result of the vehicle behavior of the host vehicle is a non-deceleration behavior, the assist mode determination unit determines to perform a fourth driving assist for providing information.

14. A driving assist method comprising:
predicting whether a vehicle behavior of a preceding vehicle is a deceleration behavior or a non-deceleration behavior;
predicting whether a vehicle behavior of a host vehicle is a deceleration behavior or a non-deceleration behavior; and
determining a mode of a driving assist to be performed for the deceleration behavior of the host vehicle, based on a combination of the predicted vehicle behavior of the preceding vehicle and the predicted vehicle behavior of the host vehicle.
